(19) United States
(12) Patent Application Publication
(10) Pub. No.: US 2011/0317063 A1
(43) Pub. Date: Dec. 29, 2011

(54) EXPOSURE CONTROL APPARATUS AND EXPOSURE CONTROL METHOD

(75) Inventor: Masaaki Toguchi, Hakusan-cho (JP)

(73) Assignee: ELMO COMPANY LIMITED, Mizuho-ku (JP)

(21) Appl. No.: 13/163,773

(22) Filed: Jun. 20, 2011

(30) Foreign Application Priority Data
Jun. 28, 2010 (JP) 2010-146068
Jun. 28, 2010 (JP) 2010-146071
Jun. 28, 2010 (JP) 2010-146075

(51) Int. Cl. H04N 5/238; H04N 5/235

(52) U.S. Cl. 348/363; 348/362; 348/E05.04; 348/E05.034

(57) ABSTRACT

An exposure control apparatus does exposure control using an exposure evaluation value EV (pv) and an exposure target value EV (sp) according to brightness signals in an exposure adjustment range ER by a plurality of exposure adjustment units. The deviation EV (err) of the exposure target value EV (sp) and the exposure evaluation value EV (pv) is found, and when the deviation EV (err) is in a steady state of a specified level or less, and exposure control is done in a gain exposure control range ER-g, the gain exposure adjustment unit 62 does exposure control using main control volume Ci-m, and the aperture compensation volume Ci-s of the aperture exposure adjustment unit 61 is also added.

This application claims the benefit of and priority from Japanese Application No. 2010-146068 filed Jun. 28, 2010, No. 2010-146071 filed Jun. 28, 2010, and No. 2010-146075 filed Jun. 28, 2010, the contents of which are incorporated herein by reference.

### BACKGROUND OF THE INVENTION

1. Field of the Invention

The present invention relates to a camera exposure control apparatus and exposure control method for automatically adjusting the exposure.

2. Description of the Related Art

With still cameras and video cameras in recent years, there are many items equipped with a so called automatic exposure function for automatically adjusting the exposure. As this kind of automatic exposure function, for example, known are mechanisms which handle a wide exposure adjustment range by switching a plurality of exposure adjustment units according to the brightness of the subject, and also control feedback so that the evaluation value calculated from the brightness value of the captured image conforms to the exposure target value, disclosed in JP-A 2004-129025 and 2003-241248. As the plurality of exposure adjustment units, an aperture exposure adjustment unit that controls the light volume that passes through the lens, a gain exposure adjustment unit that amplifies the signals from the imaging device, an electronic shutter adjustment unit that changes the storage time of the charge stored in the imaging device and the like are used.

However, with the conventional constitution using a plurality of exposure adjustment units, it was not possible to sufficiently utilize the characteristics of each exposure adjustment unit, in other words, there was the problem that it was difficult to control to the target exposure value with high responsiveness and high precision in a wide exposure adjustment range corresponding to the brightness of the subject.

### SUMMARY

An advantage of some aspects of the invention is to provide with a simple constitution an exposure control apparatus and exposure control method that can control to the target exposure value with high responsiveness and high precision in a broad exposure adjustment range.

According to an aspect of the invention, there is an exposure control apparatus comprises: an imaging device for capturing an image of a subject, and outputting a video signal including a brightness signal, a first exposure adjustment unit for adjusting exposure, a second exposure adjustment unit for adjusting exposure, in exposure adjustment speed and resolution, different from the first exposure adjustment unit, and an exposure control unit that controls exposure of the first and second exposure adjustment units by determining (i) an exposure adjustment range based on the brightness signal and (ii) an exposure control volume, wherein the exposure control volume is determined using (i) an exposure evaluation value calculated based on the brightness signal and (ii) an exposure target value demanded as a target exposure in relation to the exposure evaluation value. The exposure control unit includes; an exposure range setting unit that divides and sets the exposure adjustment range into a first exposure control range and a second exposure control range, wherein the first and second exposure control range are ranges in which the first and second exposure adjustment units mainly adjust exposure respectively, an exposure control volume setting unit that divides and sets the exposure control volume into a main adjustment volume and a compensation volume, wherein the main adjustment volume is a value for which the first and second exposure adjustment units control exposure in the first and second exposure control ranges respectively according to the brightness signal, and the compensation volume is a value for which the first exposure adjustment units controls exposure in the second range exposure adjusts ranges, and for which the second exposure adjustment unit adjusts exposure in the first exposure control ranges, an exposure compensation control unit that controls exposure of the first and second exposure adjustment units in one of the first and second exposure control range by using both of the main adjustment volume and the compensation volume, based on a deviation between the exposure target value and the exposure evaluation value.

With the exposure control apparatus of application example 1, using an exposure evaluation value calculated based on the brightness signal from an imaging device for capturing a subject and the exposure target value, exposure control is done by a first exposure adjustment unit and a second exposure adjustment unit for which the exposure adjustment speed and the resolution is different from the first exposure adjustment unit. This kind of exposure control is executed by first and second adjustment units with the exposure adjustment range corresponding to the brightness signals of the imaging device, in other words, corresponding to the brightness of the subject, divided into a first exposure control range and a second exposure control range.

One of either the first or second exposure adjustment units is set with the exposure adjustment volume for which exposure adjustment is possible divided into a main adjustment volume and a compensation volume. The exposure target value is in the first or second exposure control range, and according to the deviation of the exposure control value and the exposure evaluation value, in addition to the exposure control by one of the exposure adjustment units, the other exposure adjustment unit does exposure control using the compensation volume. Therefore, in the exposure control range, the resolution difference or the exposure adjustment speed difference is compensated by, in addition to the exposure control of one exposure adjustment unit, the exposure control of the other exposure adjustment unit.

With the exposure control apparatus of the other application example, using the exposure evaluation value calculated based on the brightness signal from the imaging device for capturing the image of the subject and the exposure target value, exposure control is done by the first exposure adjustment unit and a second exposure adjustment unit with a greater exposure adjustment speed and lower resolution than that of that first exposure adjustment unit. This kind of exposure control is executed by the first and second exposure adjustment units with the exposure adjustment range corresponding to the subject brightness divided into a first exposure control range and a second exposure control range. The first exposure control unit is set with the exposure adjustment volume for which exposure adjustment is possible divided into a main adjustment volume and a compensation volume. When the exposure target value is in the second exposure control range and the deviation of the exposure target value and the exposure evaluation value is in a steady state at a specified level or lower, in addition to the exposure control by the second exposure adjustment unit, the first exposure adjustment unit does exposure control using that compensation volume. Therefore, in the second exposure control range, in addition to the exposure control by the low resolution second exposure adjustment unit, exposure control is also performed by the high resolution first exposure adjustment unit, so it is possible to converge the exposure value to the exposure target value with a small error.

The first and second exposure adjustment units of the other application example can use a constitution which are selected from an aperture exposure adjustment unit that controls a light volume to the imaging device, a gain exposure adjustment unit that amplifies the video signal of the imaging device, and an electronic shutter adjustment unit that changes a storage time charged in the imaging device.

With the exposure control apparatus of another application example, exposure control is done by the first exposure adjustment unit and the second exposure control unit which has greater exposure adjustment speed than that first exposure adjustment unit based on the exposure evaluation value calculated based on the brightness signals from the imaging device for capturing images of the subject and the exposure target value. This kind of exposure control is executed by the first and second exposure adjustment units with the exposure adjustment range corresponding to the brightness of the subject divided into a first exposure control range and a second exposure control range. The second exposure adjustment unit is set with the exposure adjustment volume for which exposure adjustment is possible divided into a main adjustment volume and a compensation volume. The second exposure adjustment unit having this kind of special constitution executes quick exposure control according to those characteristics using the main adjustment volume when the exposure target value is in the second exposure control range. Also, when the exposure target value is in the first exposure control range and the deviation of the exposure target value and the exposure evaluation value are in a transient state of a specified level or greater, in addition to the exposure control by the first exposure adjustment unit, the second exposure adjustment unit does exposure control using the compensation volume. Therefore, in the first exposure control range, in addition to control by the first exposure adjustment unit with slow exposure adjustment speed, exposure control is also performed by the second exposure adjustment unit with a high exposure adjustment speed, so it is possible to perform quick exposure adjustment to the exposure target value.

Furthermore, with the exposure control apparatus noted in another application example, exposure adjustment is done by the first exposure adjustment unit and the second exposure adjustment unit for which the exposure adjustment speed is greater than and the resolution is lower than that of that first exposure adjustment unit based on the exposure evaluation value calculated based on the brightness signals from the imaging device for taking images of the subject and the exposure target value. The first and second exposure adjustment units do exposure control with the exposure adjustment range corresponding to the brightness of the subject divided into a first exposure control range and a second exposure control range. Also, the first exposure adjustment unit has the exposure control volume for which exposure adjustment is possible divided into a first main adjustment volume for adjusting within the first exposure control range and a first compensation volume for adjusting within the second exposure control range. Similarly, the second exposure adjustment unit has the exposure control volume for which exposure adjustment is possible set divided into a second main adjustment volume for adjusting within the second exposure control range and a second compensation volume for adjusting within the first exposure control range.

This kind of first and second exposure adjustment unit executes quick, high precision exposure control corresponding to characteristics such as the exposure adjustment speed, resolution and the like by switching the exposure control according to the exposure adjustment range and deviation. Specifically, when the exposure target value is in the second exposure control range and the deviation of the exposure target value and the exposure evaluation value are in a steady state of a specified level or less, in addition to exposure control by the second exposure adjustment unit, the first exposure adjustment unit does exposure control using the first compensation volume. Also, when the exposure target value is in the first exposure control range and the deviation of the exposure target value and the exposure evaluation value is in a transient state of a specified level or greater, in addition to exposure control by the first exposure adjustment unit, the second exposure adjustment unit does exposure control using the second compensation volume.

Therefore, in the first exposure control range, in addition to control by the slow exposure adjustment speed first exposure adjustment unit, exposure control is also performed by the high exposure adjustment speed second exposure adjustment unit, so it is possible to perform quick adjustment to the exposure target value. Also, in the second exposure control range, in addition to control by the low resolution second exposure adjustment unit, exposure control is also performed by the high resolution first exposure adjustment unit, so it is possible to perform high precision adjustment to the exposure target value. Thus, it is possible to perform quick, high precision exposure control in a broad range of the exposure adjustment range.

An other aspect of the invention is provided with an exposure control method comprises: capturing an image of a subject by an imaging device, and outputting a video signal including a brightness signal from imaging device, and controlling exposure to a first and second exposure adjustment units for adjusting exposure by determining (i) an exposure adjustment range based on the brightness and (ii) an exposure control volume, wherein the first exposure adjustment unit is different from the second exposure adjustment unit in exposure adjustment speed and resolution, and the exposure control volume is determined by an exposure evaluation value calculated based on the brightness signal and an exposure target value demanded as a target exposure in relation to the exposure evaluation value. The method includes dividing and setting the exposure adjustment range into a first exposure control range and a second exposure control range in which each of the first and second exposure adjustment units is mainly controlled respectively, dividing and setting the exposure control volume into a main adjustment volume and a compensation volume, wherein the main adjustment volume is a value for which the first and second exposure adjustment units controls exposure in the first and second exposure control ranges respectively according to the brightness signal, and the compensation volume is a value for which the first and second exposure adjustment units controls exposure in an other range of the first and second exposure control ranges, and controlling exposure to the first and second exposure adjustment units in one of the first and second exposure control range by using both of the main adjustment volume and the compensation volume, based on a deviation between the exposure target value and the exposure evaluation value.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows the schematic structure of a video camera equipped with an exposure control apparatus of an embodiment of the present invention,

FIG. 2 is a block diagram for describing the exposure control apparatus of a video camera equipped with a microcomputer,

FIG. 3 shows the relationship between the exposure control volume and the exposure adjustment range when using a plurality of exposure adjustment units,

FIG. 4 shows changes over time in the exposure value by the exposure adjustment unit,

FIG. 5 shows the exposure control process,

FIG. 6 is a flow chart for describing the response area determination process executed by the microcomputer,

FIG. 7 is a flow chart for describing the transient state exposure value distribution process,

FIG. 8 is a flow chart for describing the steady state exposure value distribution process,

FIG. 9 shows the exposure control process in the aperture exposure control range, and

FIG. 10 shows the exposure control process in the gain exposure control range.

### DESCRIPTION OF THE PREFERRED EMBODIMENTS

(1) Video Camera Constitution:

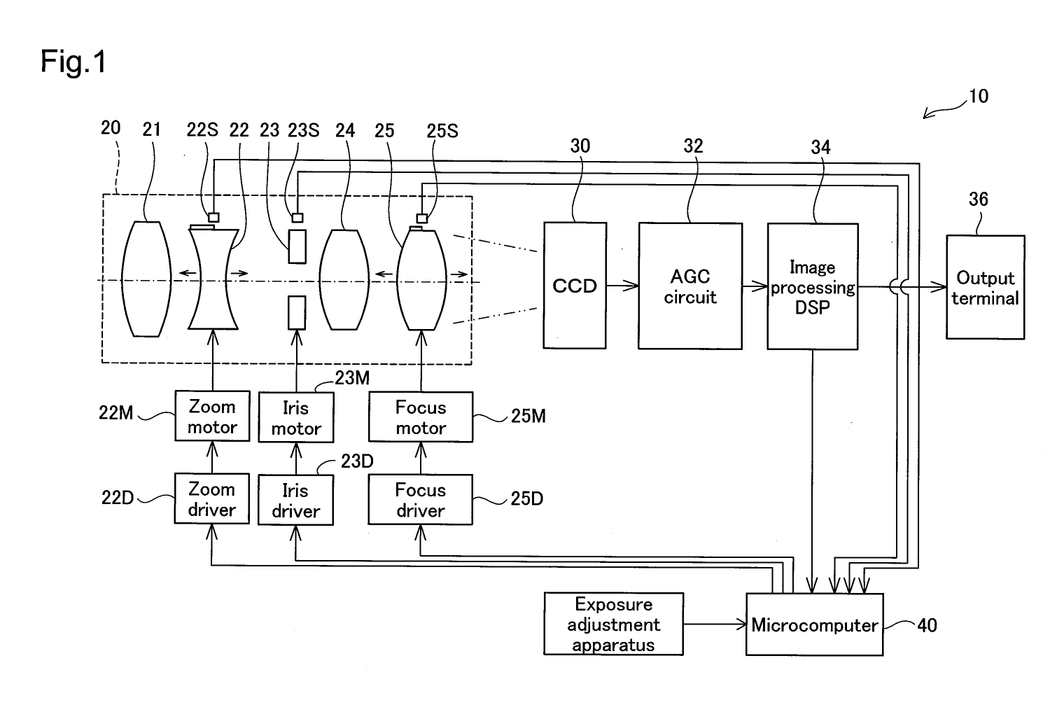

FIG. 1 shows a schematically structure of the video camera 10 as an embodiment of the present invention. As shown in FIG. 1, the video camera 10 is equipped with a lens unit 20, an imaging device 30, an AGC circuit 32, an image processing DSP (Digital Signal Processor) 34, and a microcomputer 40.

The lens unit 20 is equipped in sequence from the front-most surface of the subject side with a first lens 21 fixed within the unit, a zoom lens 22 for performing a power variation operation by moving in the optical axis direction, an iris mechanism 23 for adjusting the light volume that is transmitted within the unit, a third lens 24 fixed within the unit, and a focus lens 25 for adjusting the focal position by moving in the light optical direction. Also, with an inner focus type lens unit, there are cases when the zoom lens is called a variator lens, and the focus lens is called a compensator lens.

Connected to the zoom lens 22 is a zoom motor 22M equipped with a lead screw that moves the zoom lens 22 back or forth in the optical axis direction. The zoom motor 22M is a stepping motor, and is connected to the microcomputer 40 via a zoom driver 22D for driving the zoom motor 22M. Therefore, the zoom lens 22 is able to move within the lens unit 20 in the optical axis direction to perform a power variation operation according to the number of steps specified from the microcomputer 40.

Connected to the focus lens 25 is a focus motor 25M equipped with a lead screw for moving the focus lens 25 back or forth in the optical axis direction. The focus motor 25M is a stepping motor, and is connected to the microcomputer 40 via the focus driver 25D that drives the focus motor 25M. Therefore, the focus lens 25 is able to adjust the focus point by moving within the lens unit 20 in the optical axis direction according to the number of steps specified from the microcomputer 40.

Connected to the iris mechanism 23 is an iris motor 23M for adjusting the aperture of the iris mechanism 23. The iris motor 23M is a galvanometer, and is connected to the microcomputer 40 via an iris driver 23D that drives the iris motor 23M. Therefore, the iris mechanism 23 is able to adjust the light volume transmitted in the lens unit 20 according to the instructions from the microcomputer 40. Note that with this embodiment, we made the zoom motor 22M and the focus motor 25M be stepping motors, and the iris motor 23M be a galvanometer, but it is also possible to use other format motors such as a direct current motor or the like.

As described above, the zoom lens 22 and the focus lens 25 move in the optical axis direction within the lens unit 20. Because of that, the lens unit 20 is equipped with a first origin point sensor 22S and a second origin point sensor 25S for detecting whether these lenses moved to a predetermined origin point which is a reference position. The first origin point sensor 22S and the second origin point sensor 25S are constituted by a photo interrupter, and are connected to the microcomputer 40. Also, the iris mechanism 23 is driven so as to adjust the aperture by changing the aperture area. Because of this, it is equipped with an iris position sensor 23S for detecting the aperture volume and is connected to the microcomputer 40.

The imaging device 30 is an image sensor that receives light transmitted in the lens unit 20 and converts this light to electrical signals. An AGC circuit 32 is a circuit that inputs electrical signal output from the imaging device 30 and amplifies the output of this electrical signal to a suitable output. The image processing DSP 34 inputs electrical signals from the AGC circuit 32 and generates image data by implementing A/D conversion on these signals. The image processing DSP 34 converts image data generated in this way to composite videos signals and S video signals, and these are output via an output terminal 36 to an external device such as a television monitor, a recording device or the like. Furthermore, the image processing DSP 34 extracts brightness signals from the image data generated by the A/D converter, and is equipped with a function of outputting these to the microcomputer 40. The image processing DSP 34 is also equipped with functions for implementing various types of image processing on image data such as gamma compensation, aperture compensation, white balance adjustment and the like.

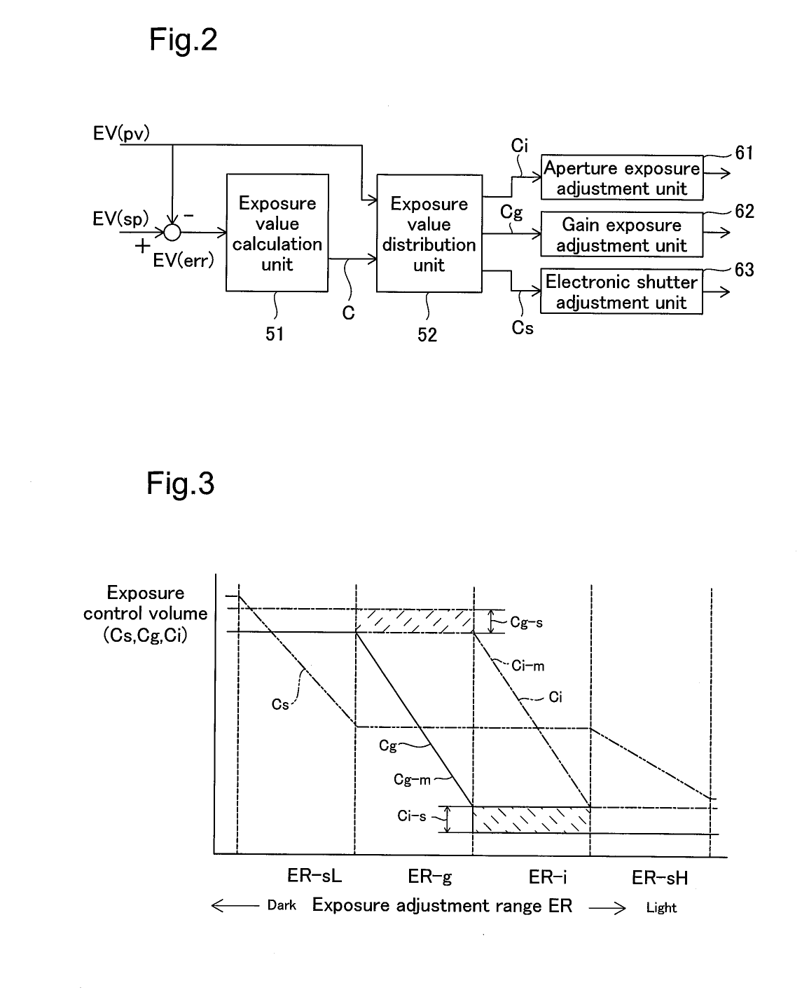

FIG. 2 is a block diagram for describing the exposure control apparatus of the video camera 10 equipped in the microcomputer 40. The exposure control apparatus uses as input the exposure evaluation value EV (pv) created based on the brightness signals output from the image processing DSP 34 (FIG. 1) and the exposure target value EV (sp) set by a value set by the user or by the microcomputer 40, and controls feedback so that the errors of these are minimized, and is equipped with an exposure value calculating unit 51, an exposure value distribution unit 52, an aperture exposure adjustment unit 61 (the first exposure adjustment unit of the present invention), a gain exposure adjustment unit 62 (the second exposure adjustment unit of the present invention), and an electronic shutter adjustment unit 63.

The exposure value calculating unit 51 inputs the deviation EV (err) found from the difference between the exposure target value EV (sp) and the exposure evaluation value EV (pv), and an exposure control volume C for which the deviation EV (err) is zero is calculated, in other words, an exposure control volume C for which the exposure evaluation value EV (pv) is converged to the exposure target value EV (sp) is calculated. Based on the exposure control volume C output from the exposure value calculating unit 51 and the exposure evaluation value EV (pv), the exposure value distribution unit 52 calculates the aperture exposure control volume Ci sent to the aperture exposure adjustment unit 61, the gain exposure control volume Cg sent to the gain exposure adjustment unit 62, and the shutter exposure control volume Cs sent to the electronic shutter adjustment unit 63. The aperture exposure adjustment unit 61 is a mechanism constituted from the iris driver 23D, the iris motor 23M, and the iris mechanism 23 described above, and using the aperture exposure control volume Ci from the exposure value distribution unit 52, the exposure value is adjusted by opening and closing the aperture of the iris mechanism 23. The gain exposure adjustment unit 62 uses the gain exposure control volume Cg from the exposure value distribution unit 52 and adjusts the exposure value by increasing and decreasing the output level of the imaging device 30. The electronic shutter adjustment unit 63 uses the shutter exposure control volume Cs from the exposure value distribution unit 52 and adjusts the exposure value by increasing and decreasing the charge storage time of the imaging device.

FIG. 3 shows the relationship between the exposure control volume C and the exposure adjustment range ER when using a plurality of exposure adjustment units. Here, as shown in FIG. 2, as the plurality of exposure adjustment units, we will describe a case of using the aperture exposure adjustment unit 61, the gain exposure adjustment unit 62, and the electronic shutter adjustment unit 63. The exposure adjustment range ER is divided into four ranges according to the brightness of the subject, in other words, it is divided into low speed shutter exposure control range ER-sL, gain exposure control range ER-g, aperture exposure control range ER-i, and high speed shutter exposure control range ER-sH.

The low speed shutter exposure control range ER-sL is a range for which exposure adjustment is done by the electronic shutter adjustment unit 63 with the subject in the darkest state, and adjustment is done with control using the shutter exposure control volume Cs, in other words, by changing the charge storage time of the electronic shutter adjustment unit 63 by a time longer than the time of 1 frame. At this time, the gain exposure control volume Cg according to the gain exposure adjustment unit 62 is a maximum value, and the aperture exposure control volume Ci according to the aperture exposure adjustment unit 61 is fully open.

The gain exposure control range ER-g is a range for which exposure adjustment is mainly done by the gain exposure adjustment unit 62 with the subject in a relatively dark state, and adjustment is done by control of the gain exposure control volume Cg, in other words, increasing and decreasing of the video signal gain, and furthermore, in the steady state described later, adjustment is done using the aperture compensation volume Ci-s secondarily by the aperture exposure adjustment unit 61. At this time, with the electronic shutter adjustment unit 63, the shutter exposure control volume Cs is a constant value.

The aperture exposure control range ER-i is a range for which exposure adjustment is mainly done by the aperture exposure adjustment unit 61 with the subject in a normal brightness state, and adjustment is done using aperture exposure control volume Ci, in other words, changing the optical aperture volume, and furthermore, in the transient state described later, adjustment is done by the gain compensation volume Cg-s secondarily by the gain exposure adjustment unit 62. At this time, with the electronic shutter adjustment unit 63, the shutter exposure control volume Cs is a constant value.

The high speed shutter exposure control range ER-sH is a range for which exposure adjustment is done by the electronic shutter adjustment unit 63 with the subject in the brightest state, and adjustment is done using shutter exposure control volume Cs, in other words, changing the charge storage time of the electronic shutter adjustment unit 63 by a time shorter than the time of 1 frame. At this time, the gain exposure adjustment unit 62 has a minimum value, and the aperture exposure adjustment unit 61 has a minimum aperture volume.

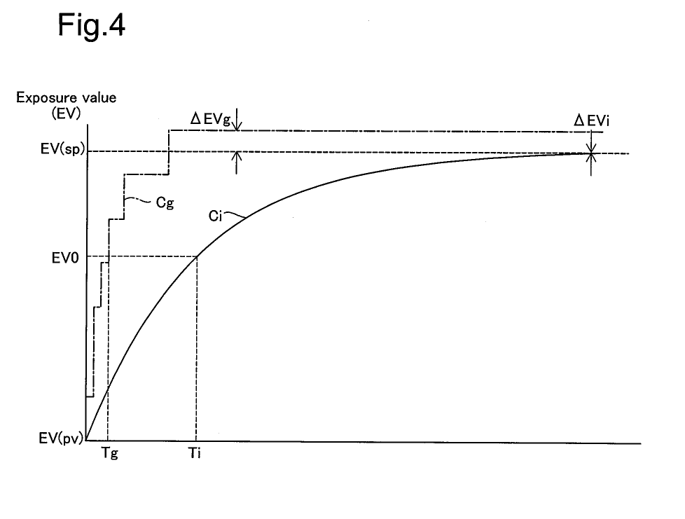

FIG. 4 is an explanatory drawing for describing the changes over time of the exposure value by the exposure adjustment unit, where the solid line indicates changes over time of the aperture exposure control volume Ci of the aperture exposure adjustment unit 61, and the dotted line indicates the changes over time of the gain exposure control volume Cg of the gain exposure adjustment unit 62. Here, when the time from the exposure evaluation value EV (pv) until a specified exposure value EV0 is reached is defined as a time constant, the time constants of the aperture exposure adjustment unit 61 and gain exposure adjustment unit 62 are respectively shown by Ti and Tg. At this time, Tg<Ti, so we can see that the gain exposure control volume Cg that undergoes exposure control by the gain exposure adjustment unit 62 is converged more quickly to the exposure target value EV (sp) than the aperture exposure control volume Ci that undergoes exposure control by the aperture exposure adjustment unit 61. Also, the exposure value EV is controlled by a specified control volume for each frame unit, and control is done with the aperture exposure control volume Ci of the aperture exposure adjustment unit 61 small and with high resolution, and on the other hand, the gain exposure control volume Cg of the gain exposure adjustment unit 62 is controlled at a digital volume with a low resolution. Thus, when the exposure value EV is controlled toward the exposure target value EV (sp), there is a final error ΔEVg by the gain exposure control volume Cg of the gain exposure adjustment unit 62, and meanwhile, there is a final error ΔEVi by the aperture exposure control volume Ci of the aperture exposure adjustment unit 61, and we can see that ΔEVg>ΔEVi. Specifically, the aperture exposure adjustment unit 61 and the gain exposure adjustment unit 62 have respectively different control characteristics in terms of the responsiveness to the exposure target value EV (sp) and resolution. Note that regarding the characteristics of the electronic shutter adjustment unit 63, though omitted here, the shutter exposure control volume Cs is set with a digital value and with different characteristics similarly to the gain exposure control volume Cg.

(2) Exposure Control Process:

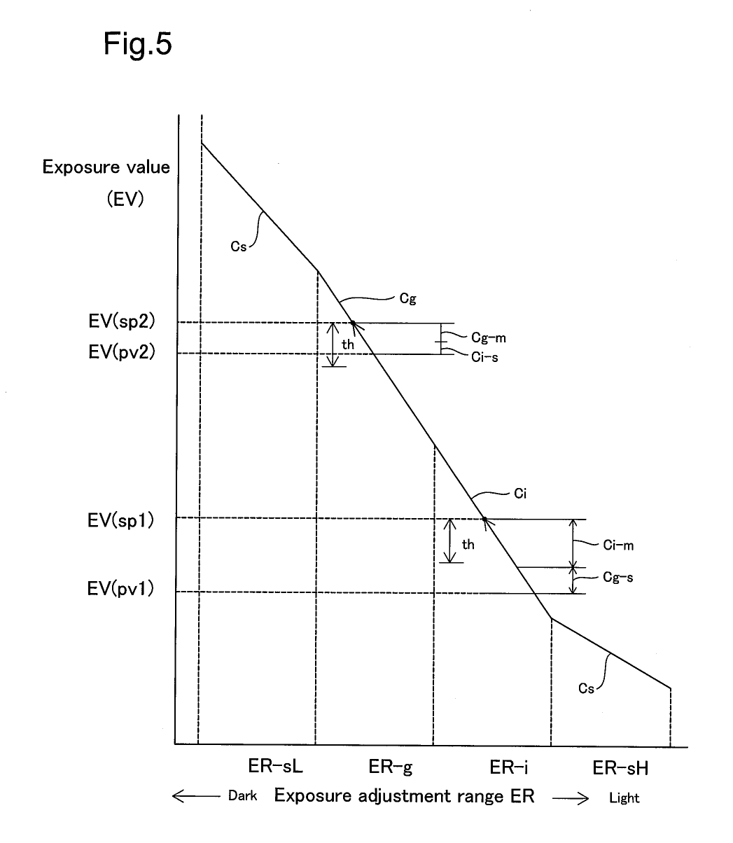

FIG. 5 shows the exposure control process. The exposure control is executed such that the exposure evaluation value EV (pv) is converged to the exposure target value EV (sp) with the exposure adjustment range ER divided into respective areas by the aperture exposure adjustment unit 61, the gain exposure adjustment unit 62, and the electronic shutter adjustment unit 63, in other words, with the aperture exposure control range ER-i which is normal brightness, by doing exposure adjustment using the aperture exposure adjustment unit 61 which is the optical adjustment means, a natural video image is created, and with the darker gain exposure control range ER-g and the low speed shutter exposure control range ER-sL, electrical exposure adjustment is performed by the gain exposure adjustment unit 62 and the electronic shutter adjustment unit 63, and also, with the high speed shutter exposure control range ER-sH that is brighter than the aperture exposure control range ER-i, electrical exposure adjustment is performed by the electronic shutter adjustment unit 63.

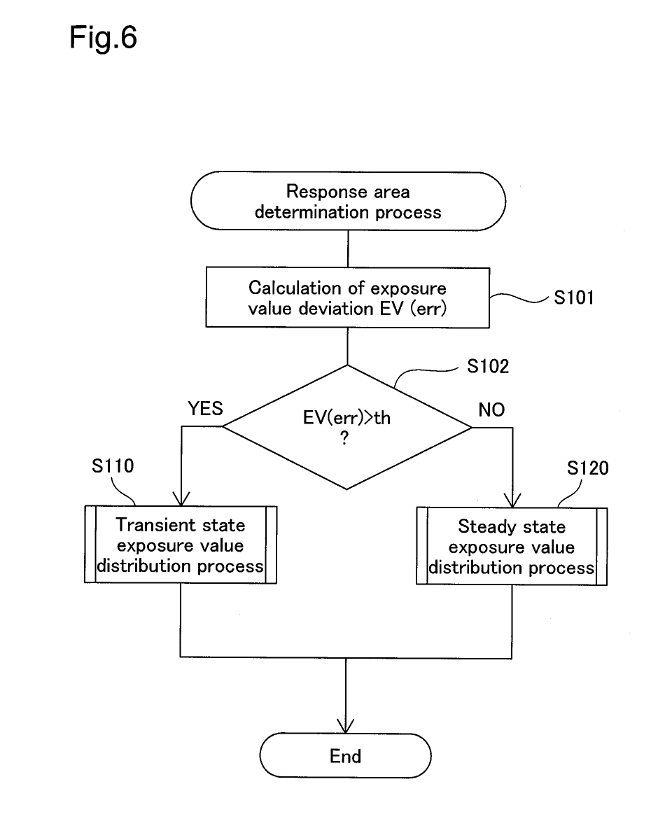

FIG. 6 is a flow chart for describing the response area determination process executed by the microcomputer 40. As shown in FIG. 6, the response area determination process is executed with the aperture exposure control range ER-i and the gain exposure control range ER-g. Specifically, the deviation EV (err) with the exposure target value EV (sp) is calculated (step S101), a determination of whether the deviation EV (err) is greater than or less than a specified threshold value th is executed (step S102), in the case of an affirmative determination, a transient state exposure value distribution process is executed (step S110), and in the case of a negative determination, a steady state exposure value distribution process is executed (step S120).

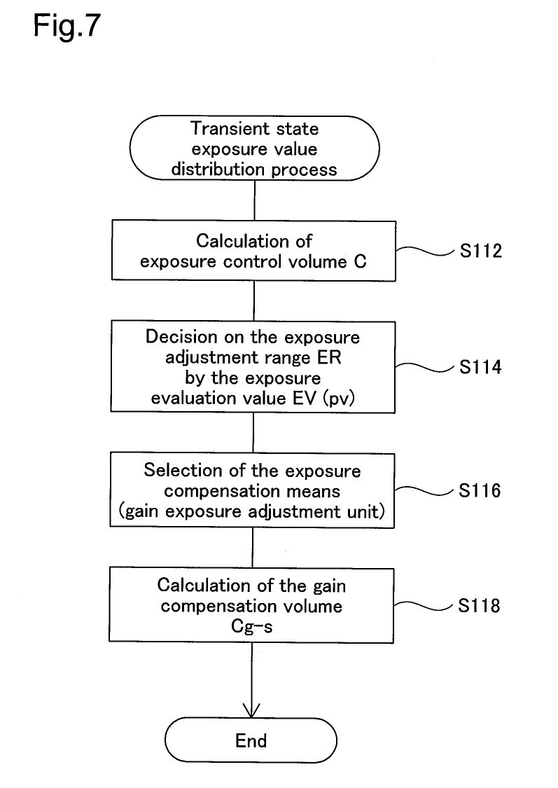

With the transient state exposure value distribution process shown in FIG. 7, the exposure control volume C is calculated (step S112), and after that, the exposure adjustment range ER is decided based on the exposure evaluation value EV (pv) (step S114). With the subsequent step S116, the exposure compensation means is selected. Specifically, if the exposure evaluation value EV (pv) is in the aperture exposure control range ER-i, the gain exposure adjustment unit 62 is selected as the exposure compensation means. Furthermore at step S118, the gain compensation volume Cg-s of the exposure compensation means is calculated. Specifically, as shown in FIG. 5, with the aperture exposure control range ER-i, when the deviation EV (err) of the exposure evaluation value EV (pv1) and the exposure target value EV (sp1) is a specified threshold value th or greater, in addition to the main control volume Ci-m of the aperture exposure control volume Ci, exposure control is done with the gain compensation volume Cg-s by the gain exposure adjustment unit 62.

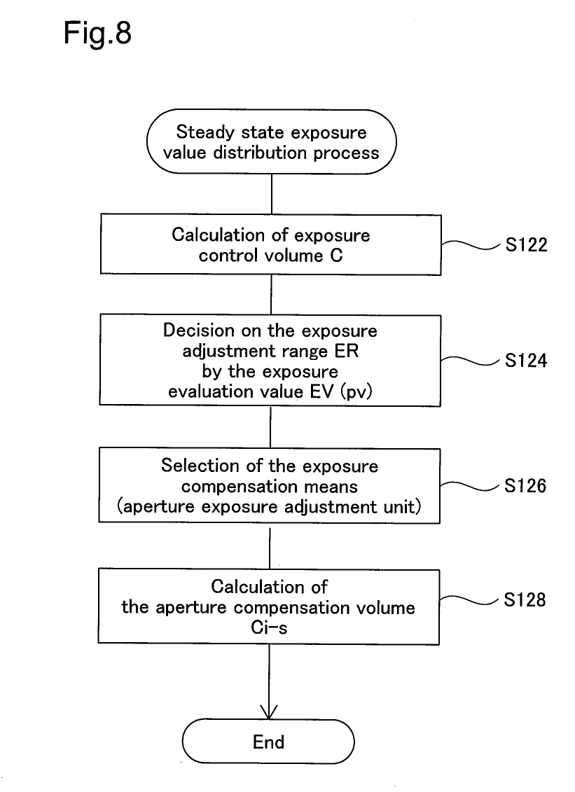

With the steady state exposure value distribution process shown in FIG. 8, the exposure control volume C is calculated (step S122), and after that, exposure adjustment range ER is decided based on the exposure evaluation value EV (pv) (step S124). With the subsequent step S126, the exposure compensation means is selected. Specifically, if the exposure adjustment range ER is the gain exposure control range ER-g, the aperture exposure adjustment unit 61 is selected as the exposure compensation means. Furthermore, with step S128, the aperture compensation volume Ci-s of the exposure compensation means is calculated. Specifically, as shown in FIG. 5, with the gain exposure control range ER-g, when the deviation EV (err) of the exposure evaluation value EV (pv2) and the exposure target value EV (sp2) is a specified threshold value th or less, in addition to the main control volume Cg-m of the gain exposure control volume Cg, exposure control is also done with the aperture compensation volume Ci-s by the aperture exposure adjustment unit 61.

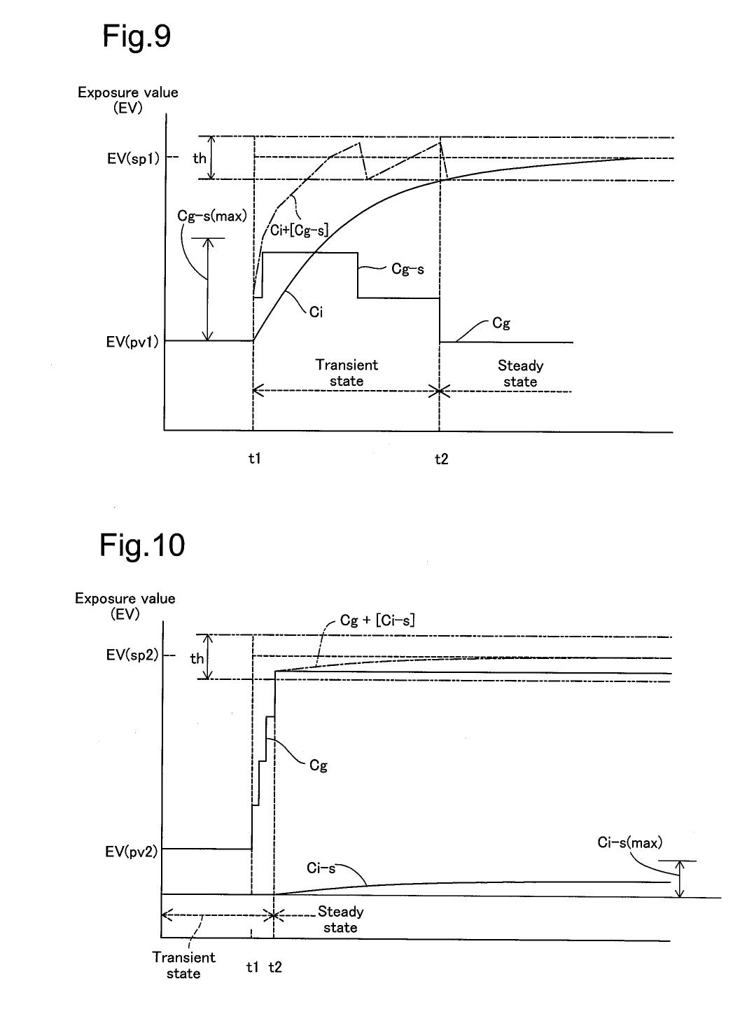

FIG. 9 is an explanatory drawing for describing the exposure control process with the aperture exposure control range ER-i, where the vertical axis shows the exposure value, and the horizontal axis shows the time. This control process shows a case of the exposure evaluation value EV (pv1) converged to the exposure target value EV (sp1). When it is determined that the deviation EV (err) of the exposure target value EV (sp1) and the exposure evaluation value EV (pv1) exceeds the specified threshold value th, the transient state exposure value distribution process is executed, specifically, in addition to the aperture exposure control volume Ci, the gain compensation volume Cg-s is also added to the exposure control volume C, and the exposure control volume C after compensation conforms to the value of (Ci+Cg). Therefore, in addition to the smooth value by the exposure control by the aperture exposure adjustment unit 61, the gain compensation volume Cg-s having a large value change by the gain exposure adjustment unit 62 is also added, and the exposure evaluation value EV (pv1) quickly approaches the exposure target value EV (sp1). Then, with time t2, when it is determined that the deviation EV (err) is a specified threshold value th or less, steady state exposure value distribution processing is executed, in other words, only exposure control by the aperture exposure control volume Ci is executed, and converging to the exposure target value EV (sp1) is done with a small error value.

FIG. 10 is an explanatory drawing for describing the exposure control process with the gain exposure control range ER-g. This control process shows a case of, from time t1, the exposure evaluation value EV (pv2) converging to the exposure target value EV (sp2). Specifically, when it is determined that the deviation EV (err) of the exposure target value EV (sp2) and the exposure evaluation value EV (pv2) exceeds a specified threshold value th to be a transient state, the high responsiveness gain exposure adjustment unit 62 is selected, and control is done using the gain exposure control volume Cg. Then, when it is determined that the deviation EV (err) is the threshold value th or less (time t2), the steady state exposure value distribution process is executed. With the steady state exposure value distribution process, in addition to the gain exposure control volume Cg, the aperture compensation volume Ci-s is also added to the exposure control volume C, and the exposure control volume C after compensation is the value of (Ci+Cg). Therefore, in addition to the high responsiveness exposure control by the gain exposure adjustment unit 62, the high resolution aperture compensation volume Ci-s by the aperture exposure adjustment unit 61 is also added, and the exposure evaluation value EV (pv2) quickly converges to the exposure target value EV (sp2).

(3) Operation and Effect of the Embodiment

With the constitution of the embodiment noted above, the following operation and effects are exhibited.

(3)-1 As shown in FIG. 9, with the aperture exposure control range ER-i, exposure control is executed at a higher resolution than with the aperture exposure adjustment unit 61, but to compensate for the slow responsiveness performance of the exposure adjustment speed Vs, exposure control by the gain exposure adjustment unit 62 with a high adjustment speed is also added, and it is possible to quickly perform exposure control to the exposure target value EV (sp).

(3)-2 As shown in FIG. 10, with the gain exposure control range ER-g, slow exposure adjustment speed is executed by the gain exposure adjustment unit 62, but to compensate for the low resolution characteristics, exposure control by a high resolution aperture exposure adjustment unit 61 is also added, and it is possible to converge to the exposure target value EV (sp) with high precision.

(3)-3 As shown in FIG. 5, in a wide range of the exposure adjustment range ER, by switching using the respective compensation values of the aperture exposure adjustment unit 61 and the gain exposure adjustment unit 62, it is possible to perform quick, high precision exposure control.

(3)-4 As shown in FIG. 2, the aperture exposure adjustment unit 61 and the gain exposure adjustment unit 62 of this embodiment are general purpose aperture exposure adjustment means, and there is no need to add a special mechanism to the conventional exposure adjustment unit, and it is possible to obtain improved responsive characteristics as well as high exposure adjustment precision.

(4) Other Embodiments

This invention is not limited to the embodiments noted above, and it is possible to implement them in various modes in a range that does not stray from the key point, and variations such as the following are also possible, for example.

(4)-1 With the embodiments noted above, in regards to the characteristics of the aperture exposure adjustment unit 61, the gain exposure adjustment unit 62, and the electronic shutter adjustment unit 63, this was constituted so as to compensate for the resolution and responsiveness of the aperture exposure adjustment unit 61 and the gain exposure adjustment unit 62, but as long as it is a method that compensates for the other exposure range characteristics according to the features of the exposure adjustment unit, it is possible to use various settings, and for the compensated exposure control range as well, it is possible to cross a plurality of ranges. Also, for these exposure adjustment units, the same types of items can be applied to constitutions for which the resolution and responsiveness differ, and for example, it is possible to have a constitution such that the range undergoing exposure control is divided into a plurality of the aperture exposure adjustment units 61, for example, and so that their resolutions and responsiveness are varied.

(4)-2 With the embodiments noted above, we described a case when the compensation volume for compensating the exposure adjustment range is constant, but it is also possible to set as appropriate, changing according to the size of the deviation and setting the compensation volume itself to the intermediate value.

(4)-3 With the embodiments noted above, as the exposure adjustment unit, we described the aperture exposure adjustment unit, the gain exposure adjustment unit, and the electronic shutter adjustment unit, but this is not limited to these, and as long as they are means that can do exposure adjustment such as a neutral density filter, mechanical shutter, liquid crystal shutter or the like, there is no particular restriction.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. An exposure control apparatus comprising:
an imaging device for capturing an image of a subject, and outputting a video signal including a brightness signal,
a first exposure adjustment unit for adjusting exposure,
a second exposure adjustment unit for adjusting exposure, in exposure adjustment speed and resolution, different from the first exposure adjustment unit, and
an exposure control unit that controls exposure of the first and second exposure adjustment units by determining (i) an exposure adjustment range based on the brightness signal and (ii) an exposure control volume, wherein the exposure control volume is determined using (i) an exposure evaluation value calculated based on the brightness signal and (ii) an exposure target value demanded as a target exposure in relation to the exposure evaluation value,
the exposure control unit includes;
an exposure range setting unit that divides and sets the exposure adjustment range into a first exposure control range and a second exposure control range, wherein the first and second exposure control range are ranges in which the first and second exposure adjustment units mainly adjust exposure respectively,
an exposure control volume setting unit that divides and sets the exposure control volume into a main adjustment volume and a compensation volume, wherein the main adjustment volume is a value for which the first and second exposure adjustment units control exposure in the first and second exposure control ranges respectively according to the brightness signal, and the compensation volume is a value for which the first exposure adjustment units controls exposure in the second range exposure adjusts ranges, and for which the second exposure adjustment unit adjusts exposure in the first exposure control ranges,
an exposure compensation control unit that controls exposure of the first and second exposure adjustment units in one of the first and second exposure control range by using both of the main adjustment volume and the compensation volume, based on a deviation between the exposure target value and the exposure evaluation value.

2. The exposure control apparatus according to claim 1, wherein
the first and second exposure adjustment units are selected from an aperture exposure adjustment unit that controls a light volume to the imaging device, a gain exposure adjustment unit that amplifies the video signal of the imaging device, and an electronic shutter adjustment unit that changes a storage time charged in the imaging device.

3. The exposure control apparatus according to claim 2, wherein
the first exposure adjustment unit has an exposure adjustment speed lower than the second exposure adjustment unit, and a resolution greater than the second exposure adjustment unit, and
the exposure compensation control unit is configured to control the first exposure adjustment unit in the second exposure control range with the compensation volume, when the expose control is performed in the second exposure control range, and the deviation does not exceed a predetermined volume.

4. The exposure control apparatus according to claim 2 wherein
the first exposure adjustment unit has an exposure adjustment speed lower than the second exposure adjustment unit, and a resolution greater than the second exposure adjustment unit, and
the exposure compensation control unit is configured to control the second exposure adjustment unit in the first exposure control range with the compensation volume, when the expose control is performed in the first exposure control range, and the deviation exceeds a predetermined volume.

5. The exposure control apparatus according to claim 2 wherein
the first exposure adjustment unit has an exposure adjustment speed lower than the second exposure adjustment unit, and a resolution greater than the second exposure adjustment speed,
the exposure compensation control unit is configured (i) to control the first exposure adjustment unit in the second exposure control range with the compensation volume, when the expose control is performed in the second exposure control range, and the deviation does not exceed a first predetermined volume, and (ii) to control the second exposure adjustment unit in the first exposure control range with the compensation volume, when the expose control is performed in the first exposure control range, and the deviation exceeds a second predetermined volume.

6. An exposure control method comprising:
capturing an image of a subject by an imaging device, and
outputting a video signal including a brightness signal from imaging device, and
controlling exposure to a first and second exposure adjustment units for adjusting exposure by determining (i) an exposure adjustment range based on the brightness and (ii) an exposure control volume, wherein the first exposure adjustment unit is different from the second exposure adjustment unit in exposure adjustment speed and resolution, and the exposure control volume is determined by an exposure evaluation value calculated based on the brightness signal and an exposure target value demanded as a target exposure in relation to the exposure evaluation value,
wherein the method includes
dividing and setting the exposure adjustment range into a first exposure control range and a second exposure control range in which each of the first and second exposure adjustment units is mainly controlled respectively,
dividing and setting the exposure control volume into a main adjustment volume and a compensation volume, wherein the main adjustment volume is a value for which the first and second exposure adjustment units controls exposure in the first and second exposure control ranges respectively according to the brightness signal, and the compensation volume is a value for which the first and second exposure adjustment units controls exposure in an other range of the first and second exposure control ranges, and
controlling exposure to the first and second exposure adjustment units in one of the first and second exposure control range by using both of the main adjustment volume and the compensation volume, based on a deviation between the exposure target value and the exposure evaluation value.

7. The exposure control method according to claim 6, wherein
the first and second exposure adjustment units are selected from an aperture exposure adjustment unit that controls a light volume to the imaging device, a gain exposure adjustment unit that amplifies the video signal of the imaging device, and an electronic shutter adjustment unit that changes a storage time charged in the imaging device.

8. The exposure control method according to claim 7, wherein
the first exposure adjustment unit has an exposure adjustment speed lower than the second exposure adjustment unit, and a resolution greater than the second exposure adjustment unit, and
controlling the first exposure adjustment unit in the second exposure control range with the compensation volume, when the expose control is performed in the second exposure control range, and the deviation does not exceed a predetermined volume.

9. The exposure control method according to claim 7, wherein
the first exposure adjustment unit has an exposure adjustment speed lower than the second exposure adjustment unit, and a resolution greater than the second exposure adjustment speed,
controlling the first exposure adjustment unit in the second exposure control range with the compensation volume, when the expose control is performed in the second exposure control range, and the deviation does not exceed a first predetermined volume, and
controlling the second exposure adjustment unit in the first exposure control range with the compensation volume, when the expose control is performed in the first exposure control range, and the deviation exceeds a second predetermined volume.
